(19) United States
(12) Patent Application Publication
(10) Pub. No.: US 2026/0273862 A1
(43) Pub. Date: Sep. 17, 2026

(54) AUTOMATICALLY APPLYING ADHESIVE FOR THREE-DIMENSIONAL PRINTING

(71) Applicant: International Business Machines Corporation, Armonk, NY (US)

(72) Inventors: Gwilym Benjamin Lee NEWTON, Winchester (GB); Jonah Benjamin Michael LUCKETT, Derby (GB); EMMA JANE DAWSON, Eastleigh (GB); Elizabeth Jane MAPLE, Hampshire (GB)

(21) Appl. No.: 19/222,166

(22) Filed: May 29, 2025

(30) Foreign Application Priority Data
Mar. 17, 2025 (GB) 2503852.2

(51) Int. Cl. B29C 64/393; B29C 64/118; B29C 64/295; B29C 64/336; B33Y 10/00; B33Y 50/02

(52) U.S. Cl. CPC B29C 64/393; B29C 64/118; B29C 64/295; B29C 64/336; B33Y 10/00; B33Y 50/02

(57) ABSTRACT

In some implementations, a computer system may receive a digital model of an object to be printed on a three-dimensional printer that includes a print bed, and may analyze the digital model to determine a footprint of the object on the print bed. The computer system may cause the three-dimensional printer to apply a first layer of adhesive on the footprint, and may cause the three-dimensional printer to print a layer of filament material above the first layer of adhesive. The computer system may analyze the digital model to identify a stress point, and may cause the three-dimensional printer to apply a second layer of adhesive at the stress point based on identifying the stress point.

### CROSS-REFERENCE TO RELATED APPLICATION

This application claims priority to UK Patent Application No. 2503852.2, entitled “AUTOMATIC APPLICATION OF ADHESIVE AGENT,” and filed on Mar. 17, 2025. The entire contents of the above-referenced application are expressly incorporated herein by reference.

### BACKGROUND

Three-dimensional (3D) printing technology has been applied in multiple fields. Various techniques have been developed to create and remove objects from print surfaces in three-dimensional printing processes.

### SUMMARY

Some aspects described herein relate to a method. The method may include receiving a digital model of an object to be printed on a three-dimensional printer that includes a print bed, and analyzing the digital model to determine a footprint of the object on the print bed. The method may include causing the three-dimensional printer to apply a first layer of adhesive on the footprint, and causing the three-dimensional printer to print a layer of filament material above the first layer of adhesive. The method may include analyzing the digital model to identify a stress point, and causing the three-dimensional printer to apply a second layer of adhesive at the stress point based on identifying the stress point.

Some aspects described herein relate to a computer system. The computer system may include a processor set, one or more computer-readable storage media, and program instructions stored on the one or more computer-readable storage media to cause the processor set to perform operations. The operations may include receiving a digital model of an object to be printed on a three-dimensional printer that includes a print bed, and analyzing the digital model to determine a footprint of the object on the print bed. The operations may include causing the three-dimensional printer to apply a first layer of adhesive on the footprint, and causing the three-dimensional printer to print a layer of filament material above the first layer of adhesive. The operations may include analyzing the digital model to identify a stress point, and causing the three-dimensional printer to apply a second layer of adhesive at the stress point based on identifying the stress point, wherein the first layer of adhesive and the second layer of adhesive are applied using a nozzle-based or bed-based adhesive application system.

Some aspects described herein relate to a computer program product. The computer program product may include one or more computer-readable storage media and program instructions stored on the one or more computer-readable storage media to perform operations. The operations may include receiving a digital model of an object to be printed on a three-dimensional printer that includes a print bed, and analyzing the digital model to determine a footprint of the object on the print bed. The operations may include causing the three-dimensional printer to apply a first layer of adhesive on the footprint, and causing the three-dimensional printer to print a layer of filament material above the first layer of adhesive. The operations may include analyzing the digital model to identify a stress point, and causing the three-dimensional printer to apply a second layer of adhesive at the stress point based on identifying the stress point, wherein the first layer of adhesive and the second layer of adhesive are applied via a piping system embedded in the print bed.

### BRIEF DESCRIPTION OF THE DRAWINGS

FIG. 1 is a diagram of an example computing environment for automatically applying adhesive for three-dimensional printing, as described herein.

FIG. 2 is a diagram of example components of a three-dimensional printer.

FIGS. 3A-3E are diagrams depicting example steps for automatically applying adhesive by the three-dimensional printer.

FIGS. 4A-4C are diagrams depicting example print beds of the three-dimensional printer.

FIGS. 5A-5H are diagrams of an example associated with automatically applying adhesive for three-dimensional printing.

FIG. 6 is a diagram depicting example pseudocode capable of being executed by the three-dimensional printer.

FIG. 7 is a flowchart of an example process associated with automatically applying adhesive for three-dimensional printing.

### DETAILED DESCRIPTION

The following detailed description of example implementations refers to the accompanying drawings. The same reference numbers in different drawings may identify the same or similar elements.

Three-dimensional printing has become a widely used manufacturing technique for creating complex shapes and objects. However, adhesion and release of three-dimensional printed objects from a print bed of a three-dimensional printer can be challenging. On one hand, the object must stick well enough to the print bed to prevent the object from detaching during the printing process. On the other hand, the object must be easily removable from the print bed without damaging either the object or the print bed. Current methods for addressing these challenges often rely on the manual application of adhesives or release agents, which can be time-consuming and unreliable. Moreover, manual application can be prone to errors, such as applying too much or too little adhesive material, or applying the adhesive unevenly. This can lead to defects in the printed object, reduced print quality, and increased material waste. Thus, current methods for three-dimensional printing consume computing resources (e.g., processing resources, memory resources, communication resources, and/or the like), networking resources, and/or the like associated with generating damaged unusable objects due to detachment during a three-dimensional printing process, generating damaged unusable objects upon removal from a three-dimensional printer, wasting materials and three-dimensional printer resources by generating damaged unusable objects, and/or the like.

Some implementations described herein provide a computer system for automatically applying adhesive for three-dimensional printing. For example, the computer system may receive a digital model of an object to be printed on a three-dimensional printer that includes a print bed, and may analyze the digital model to determine a footprint of the object on the print bed. The computer system may cause the three-dimensional printer to apply a first layer of adhesive on the footprint, and may cause the three-dimensional printer to print a layer of filament material above the first layer of adhesive. The computer system may analyze the digital model to identify a stress point, and may cause the three-dimensional printer to apply a second layer of adhesive at the stress point based on identifying the stress point.

In this way, the computer system automatically applies adhesive for three-dimensional printing. For example, the computer system may optimize adhesion and release of three-dimensional printed objects from a print bed by automating the application of adhesives. The computer system may reduce variability in the printing process and may minimize a risk of defects caused by human error. The computer system may cause precise application of adhesive, which reduces material waste, decreases the likelihood of print quality issues, and enables the production of complex geometries and shapes. Furthermore, the computer system may optimize print bed utilization and increase overall throughput of the three-dimensional printer. Thus, the computer system conserves computing resources, networking resources, and/or the like that would otherwise have been consumed by generating damaged unusable objects due to detachment during a three-dimensional printing process, generating damaged unusable objects upon removal from a three-dimensional printer, wasting materials and three-dimensional printer resources by generating damaged unusable objects, and/or the like.

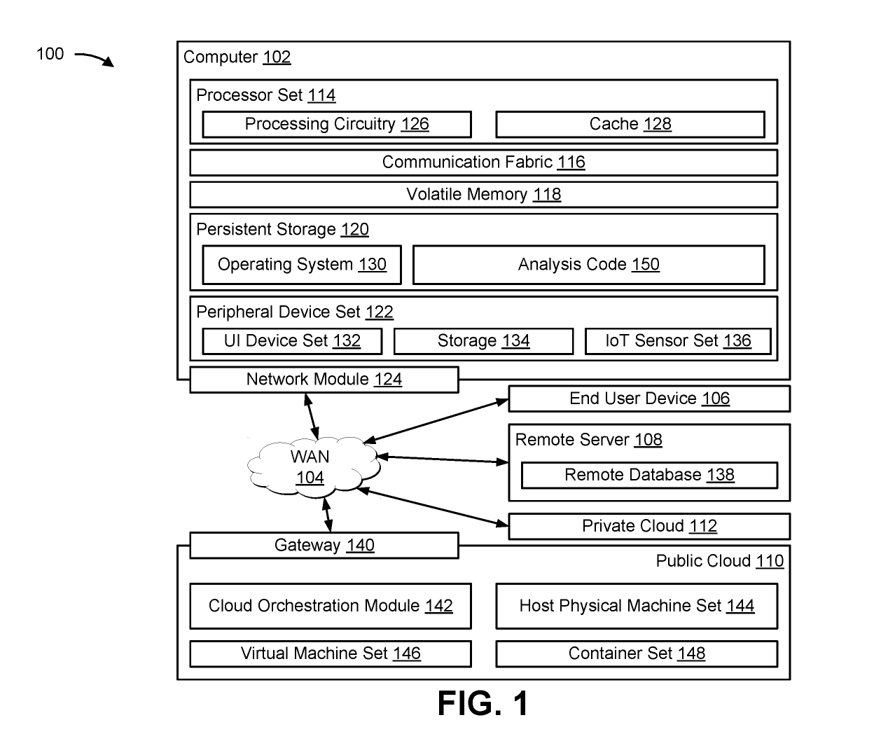

FIG. 1 is a diagram of an example computing environment 100 for automatically applying adhesive for three-dimensional printing, as described herein.

Computing environment 100 contains an example of an environment for the execution of at least some of the computer code involved in performing the inventive methods, such as analysis code 150 (e.g., code for automatically applying adhesive for three-dimensional printing). In addition to analysis code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and analysis code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in analysis code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

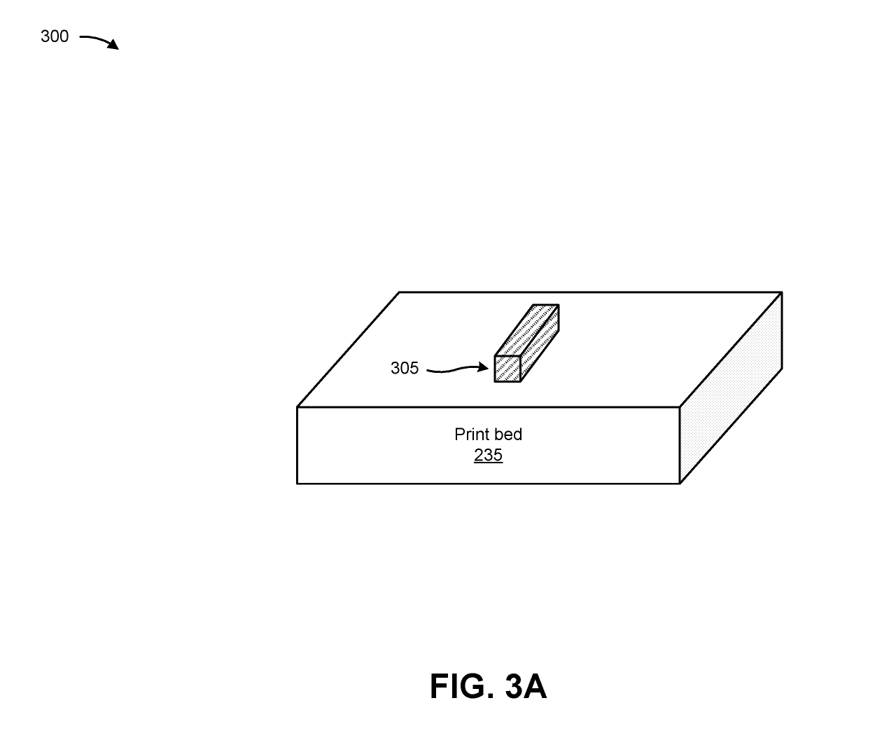

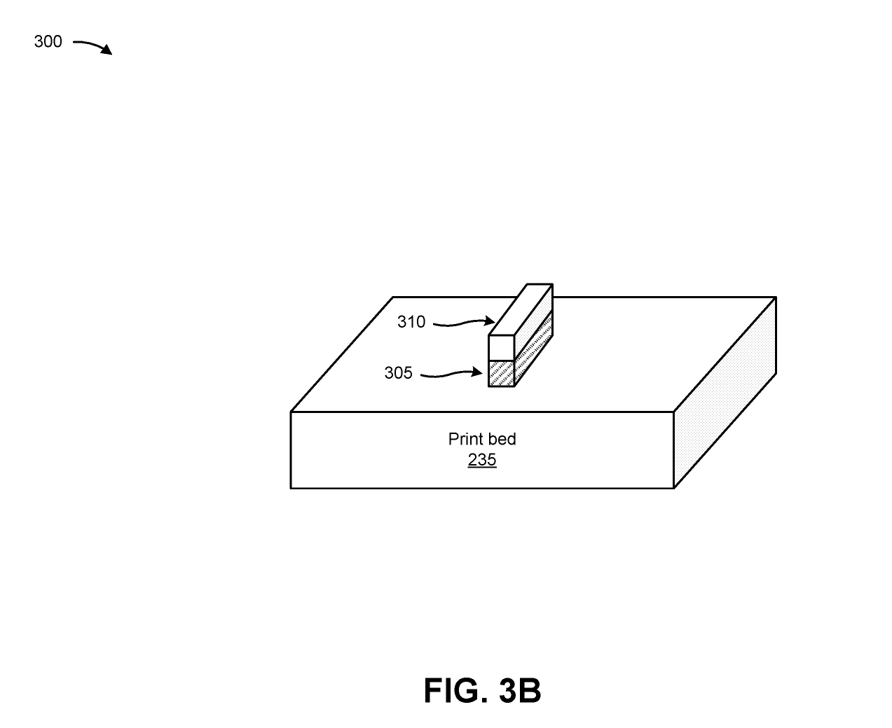

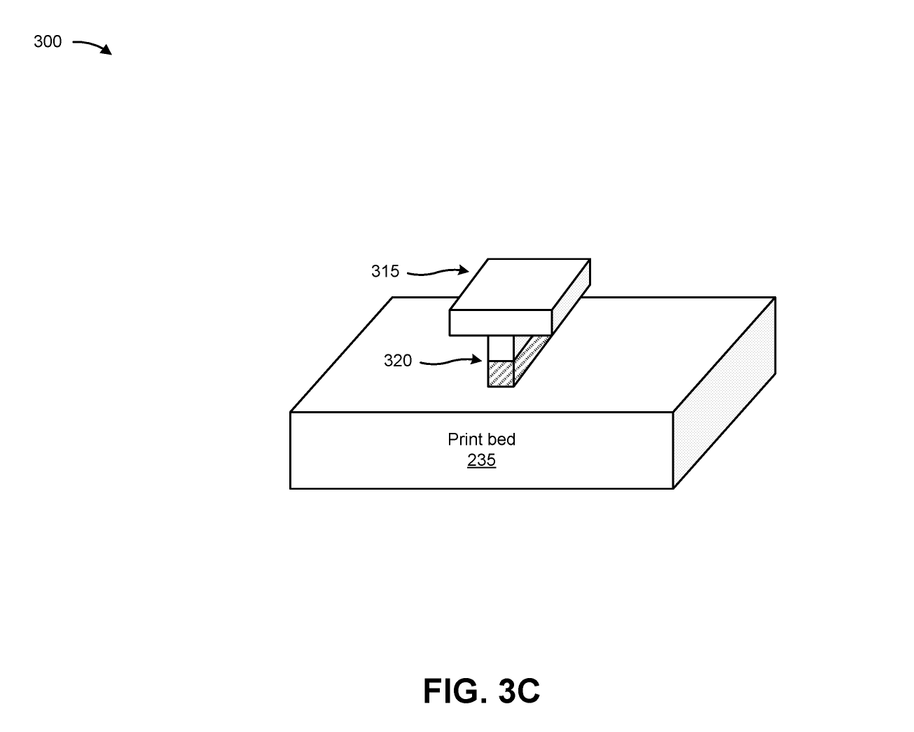

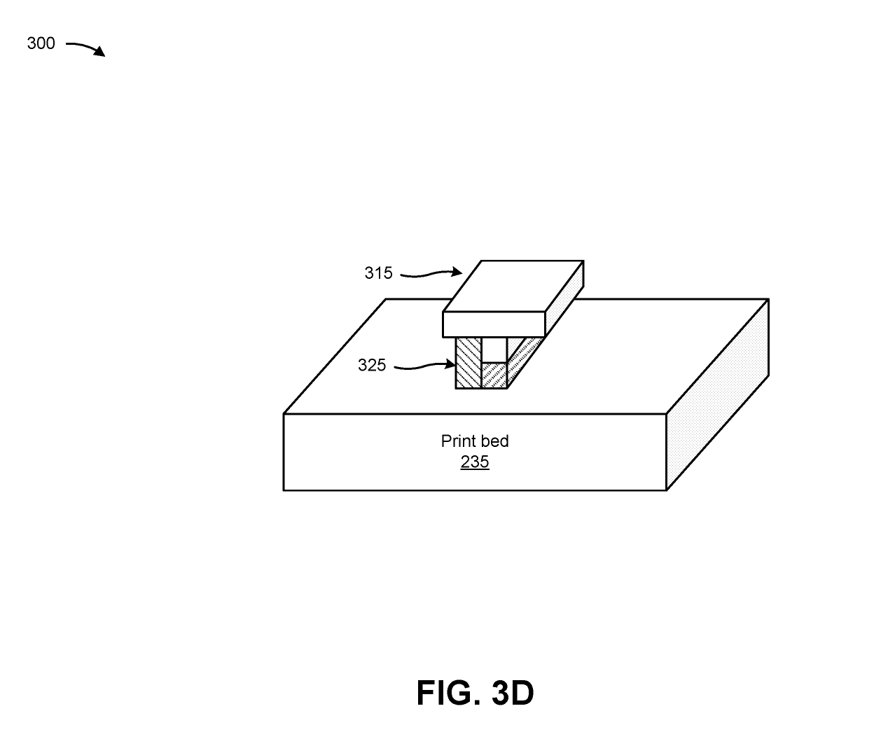

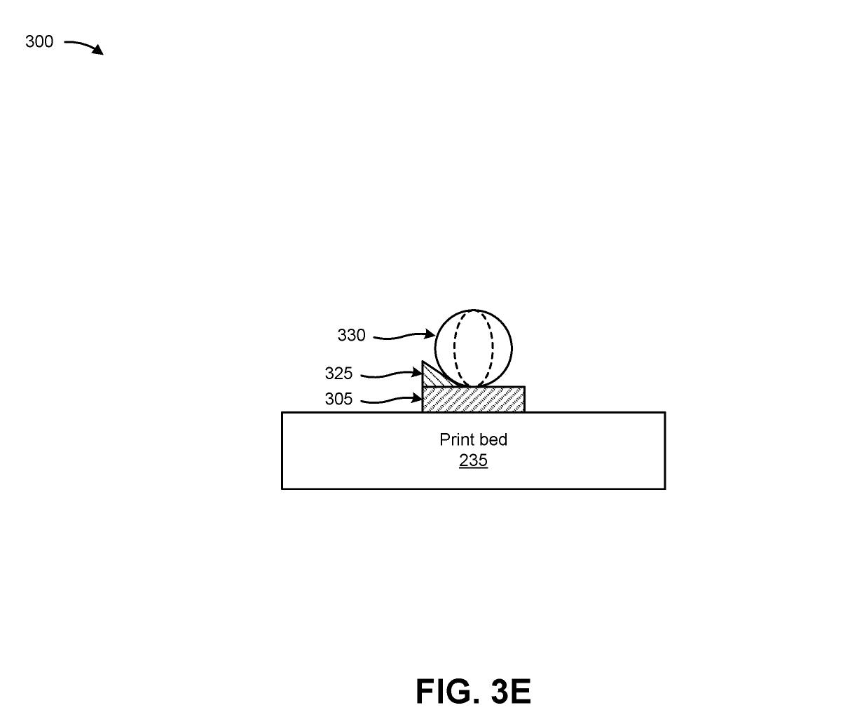

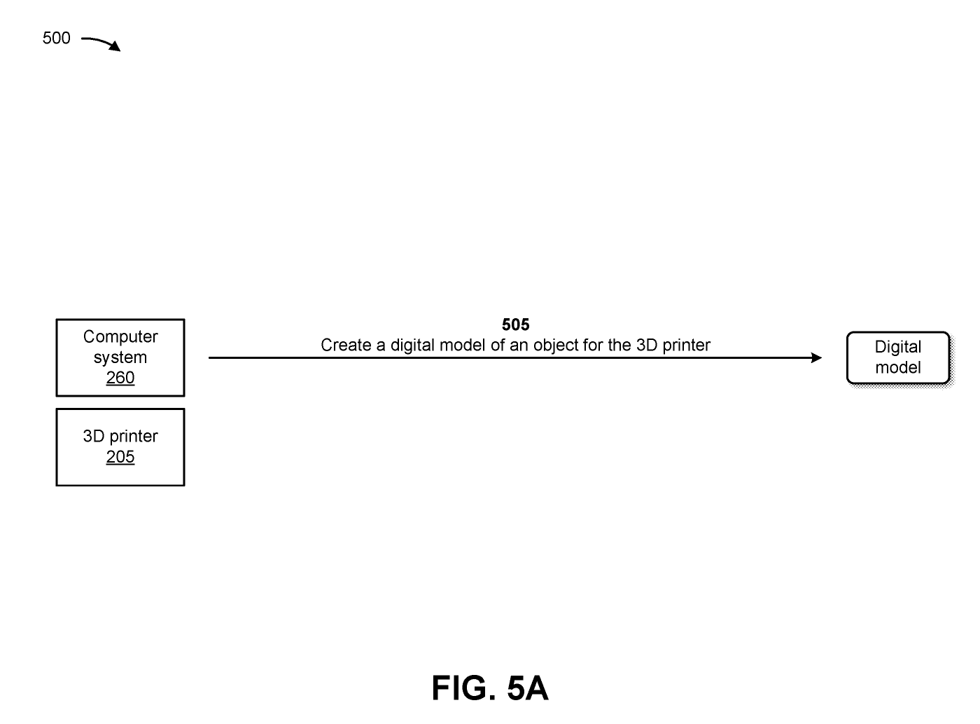

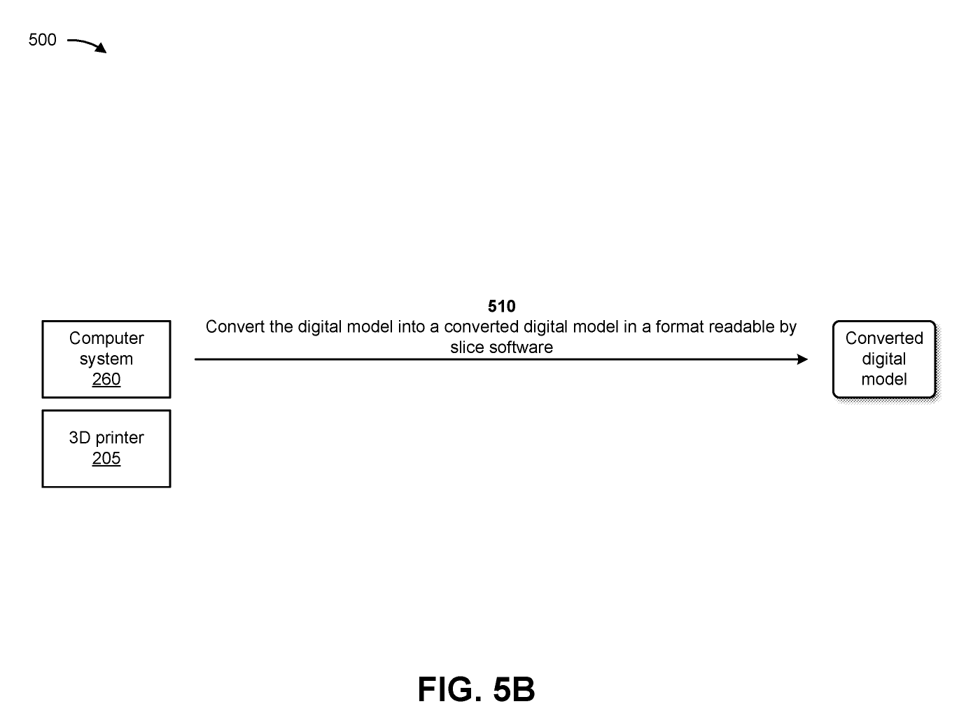

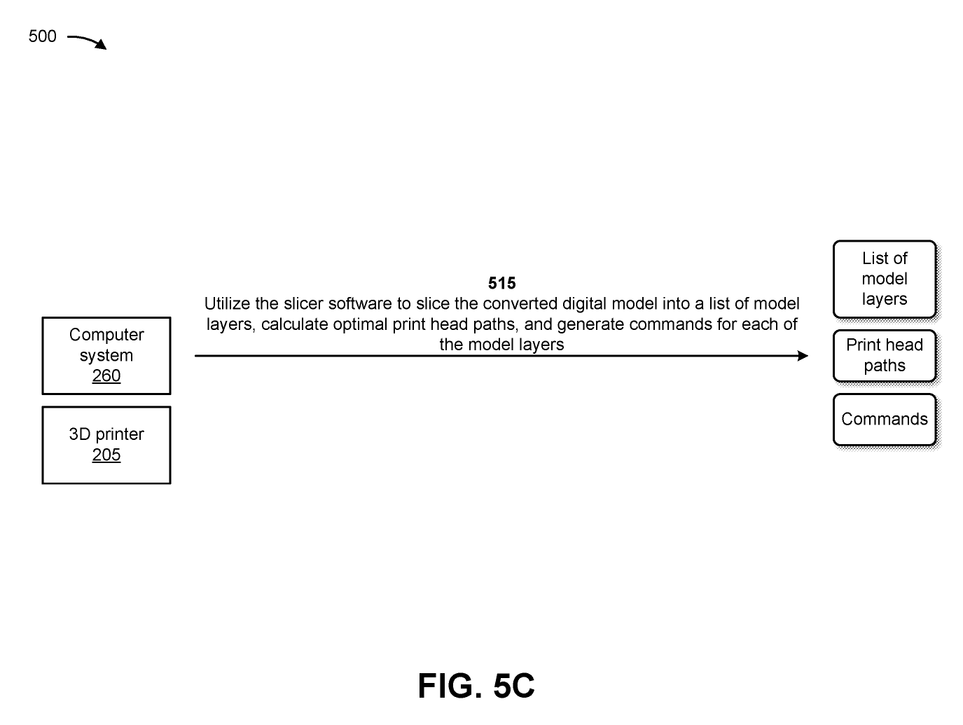

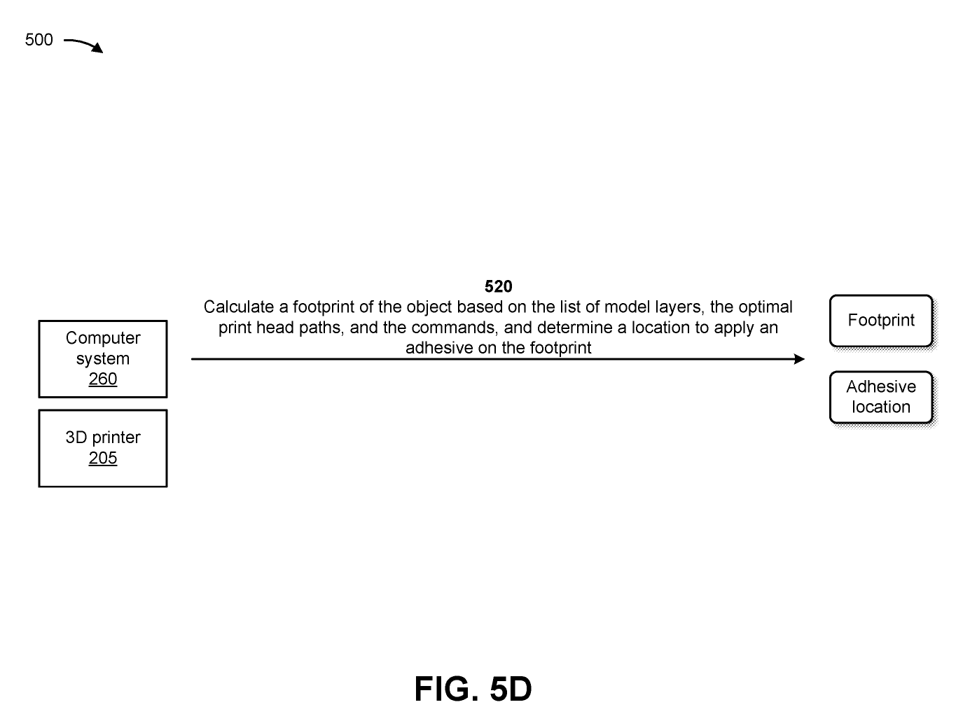

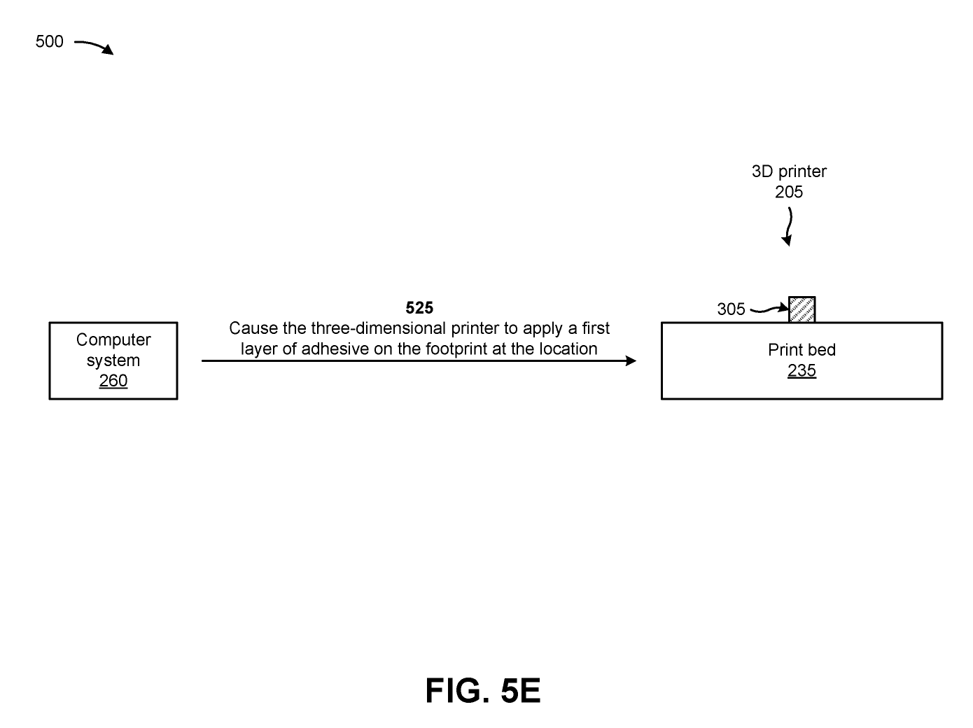

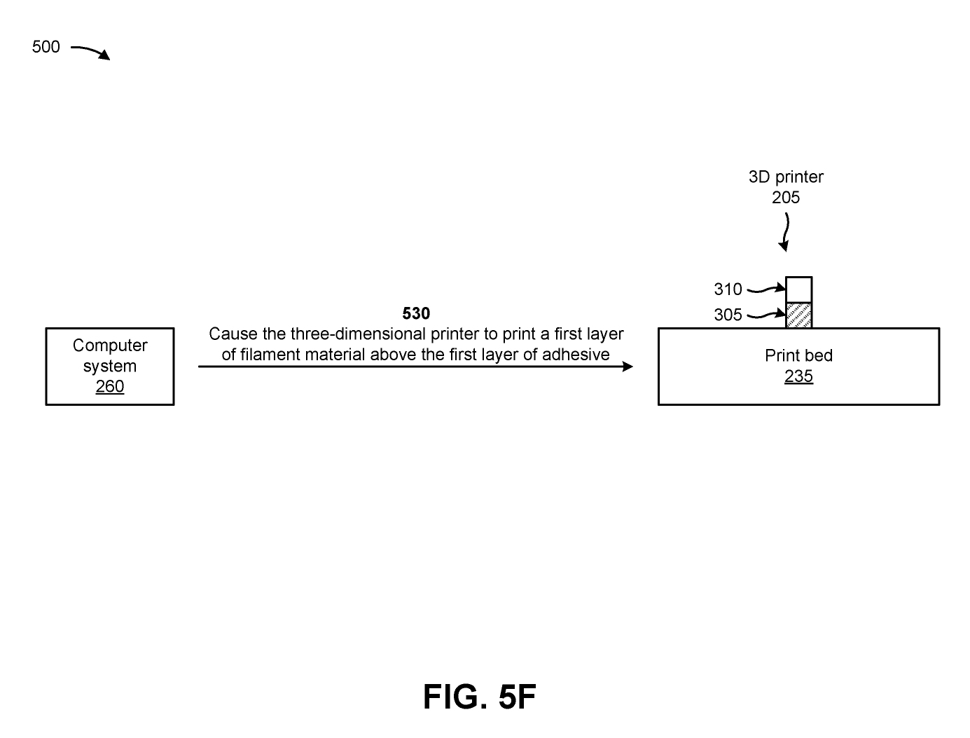

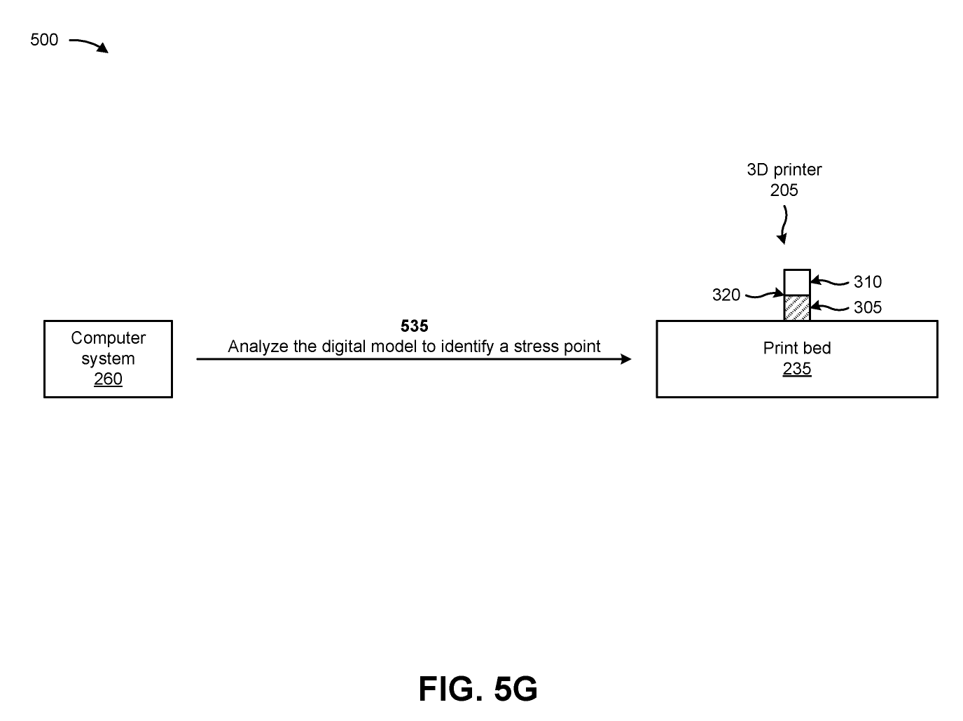

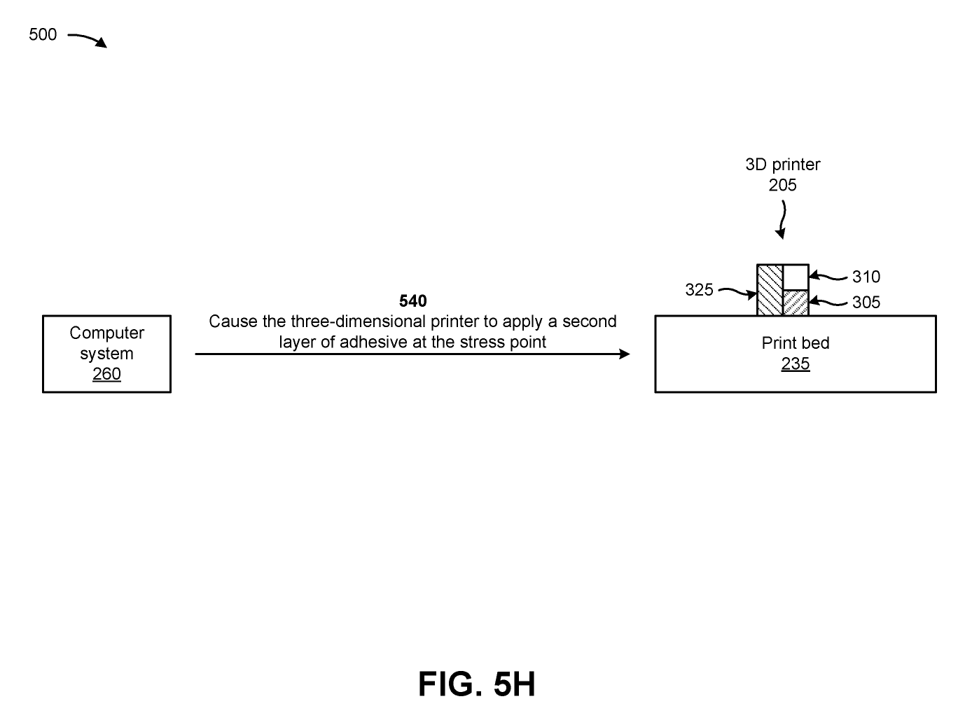

The code included in the analysis code 150 typically includes at least some of the computer code involved in performing one or more operations described herein, such as the operations of implementation 200 in FIGS. 5A-5H and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

As used herein, the term “G-code” may include a programming language used to control three-dimensional printers and other computer numerical control (CNC) machines. G-code may include a series of commands that instruct the three-dimensional printer on where to move, how fast to move, and when to extrude material. For example, the commands may include machine-level instructions required to print an object (e.g., “move print head to location X, Y” or “extrude Z amount of material”). M-code (e.g., a programming language used in machines) may also be utilized in CNC machining, and may be utilized with G-code to control various machine functions that are not directly related to the motion of the tool.

As used herein, the term “slicer” may include a software tool that can convert user-designed three-dimensional models into G-code instructions. In the context of three-dimensional printing, a slicer may include specialized software that converts a digital three-dimensional model into instructions (e.g., typically in G-code format) that a three-dimensional printer can execute to create a physical object.

In some implementations, the steps to print a three-dimensional may include creating a three-dimensional model using computer-aided design (CAD) software; converting the three-dimensional model to a format readable by the slicer software; utilizing the slicer software to generate G-code, which slices the model into layers, calculates optimal print head paths, and generates G-code commands for each layer; and utilizing the G-code with a three-dimensional printer. A three-dimensional printer may have knowledge of an available print area based on firmware utilized by the three-dimensional printer. There are several different types of firmware available for each three-dimensional printer, and such firmware may enable parameters such as print bed size to be adjusted to obtain an absolute maximum print area.

As used herein, the terms “five-dimensional” or “5D” may be utilized in the context of three-dimensional printing, where additional rotational axes are used. As used herein, the terms “three-dimensional printing” or “3D printing” may include five-dimensional printing or 5D printing. Depending on requirements of a digital model being printed, three-dimensional printing may utilize many different types of filament material, such as plastics (e.g., polylactic acid (PLA), polyethylene terephthalate glycol (PETG), acrylonitrile styrene acrylate (ASA), and/or the like), metals (e.g., bronze, copper, and/or the like), resins, powders, and/or the like. In some implementations, several adhesives and methods may be utilized for good adhesion of three-dimensional printed models to a print bed. The choice of adhesive may depend on a selected filament material and a print bed surface. Typical adhesives may include polyvinyl alcohol (PVA) glue, hairspray, acrylonitrile butadiene styrene (ABS) slurry, and/or the like. Many of these materials may also act as release agents. The choice of release agent may depend on a selected filament material and a print bed surface.

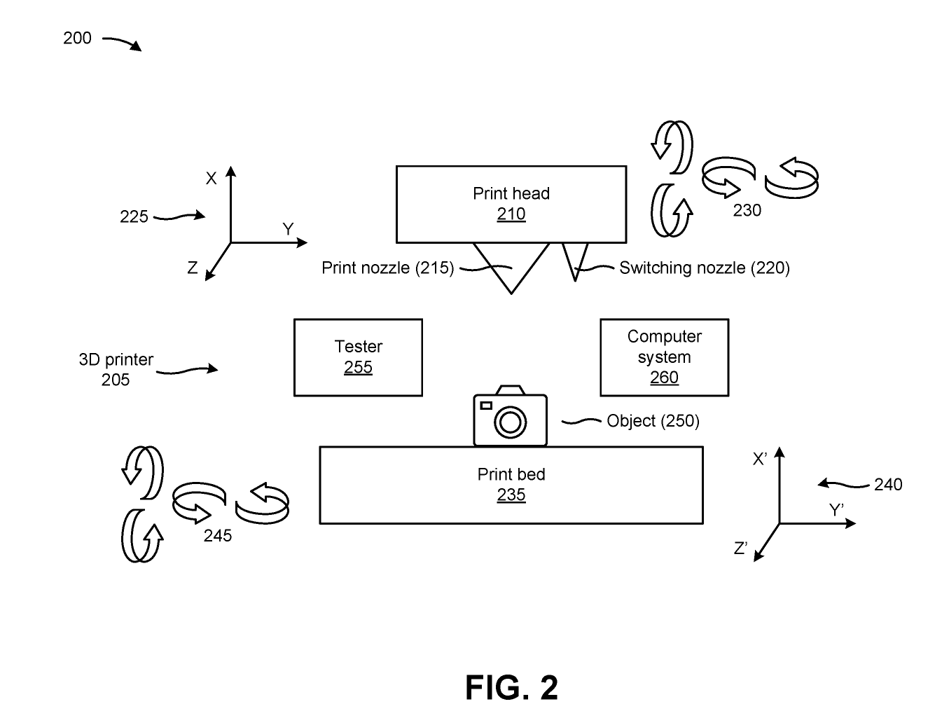

FIG. 2 is a diagram of example components 200 of a three-dimensional printer 205. As shown in FIG. 2, the three-dimensional printer 205 may include a print head 210 with a print nozzle 215 and a switching nozzle 220, a print bed 235 (e.g., for printing an object 250), a tester 255, and a computer system 260. The three-dimensional printer 205 may print the object 250. The three-dimensional printer 205 may also include an extruder that melts and deposits a filament material (not depicted) using the print nozzle 215, a heater (not depicted), and a cooling fan (not depicted).

The print head 210 may include a controller, a frame, motion components, and a power supply not depicted in FIG. 2. The print head 210 may be responsible for depositing materials, such as melted plastic, metal, or ceramics, to create the desired object layer-by-layer. The print head 210 may include the print nozzle 215 (e.g., a small opening through which molten material (e.g., filament) is extruded), the switching nozzle 220 (e.g., a small opening through which an adhesive is provided), a heating element (e.g., to heat the print nozzle 215 and the switching nozzle 220 to melt a material), an extruder (e.g., a mechanism that pushes the material through a nozzle), a temperature control system that regulates the temperature of the nozzle and the surrounding areas, and a motion system that moves the print head 210 back and forth, side to side, and up and down to create the desired pattern and object shape.

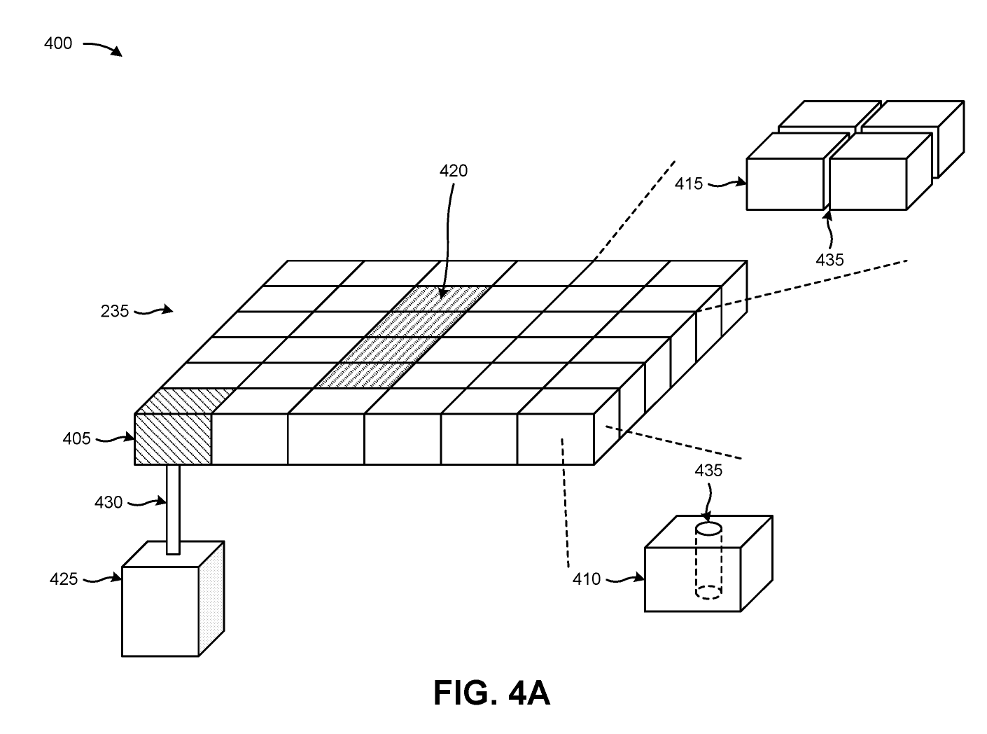

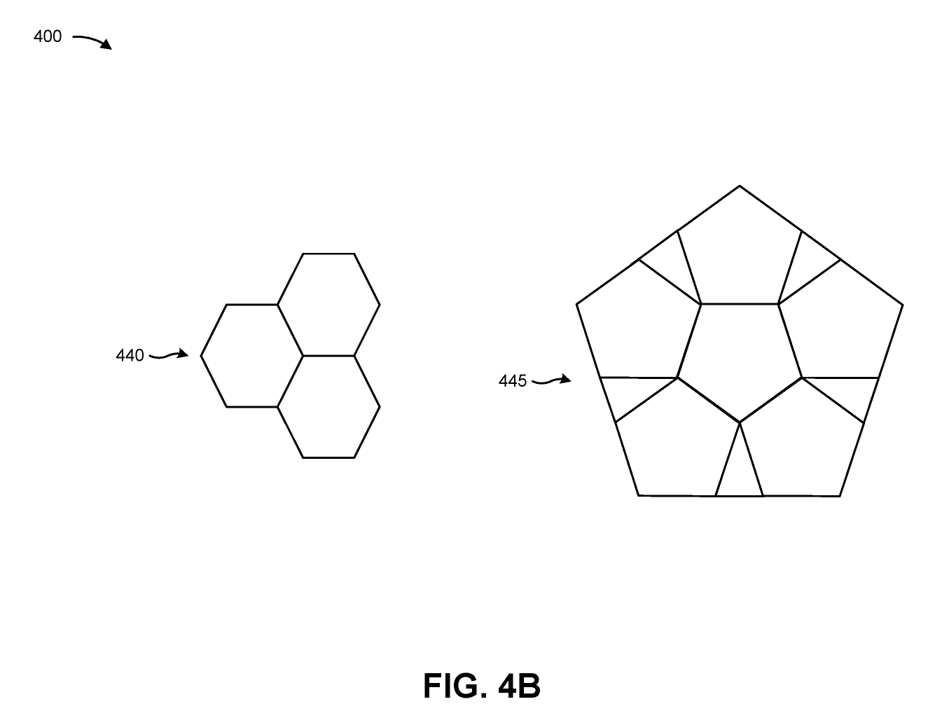

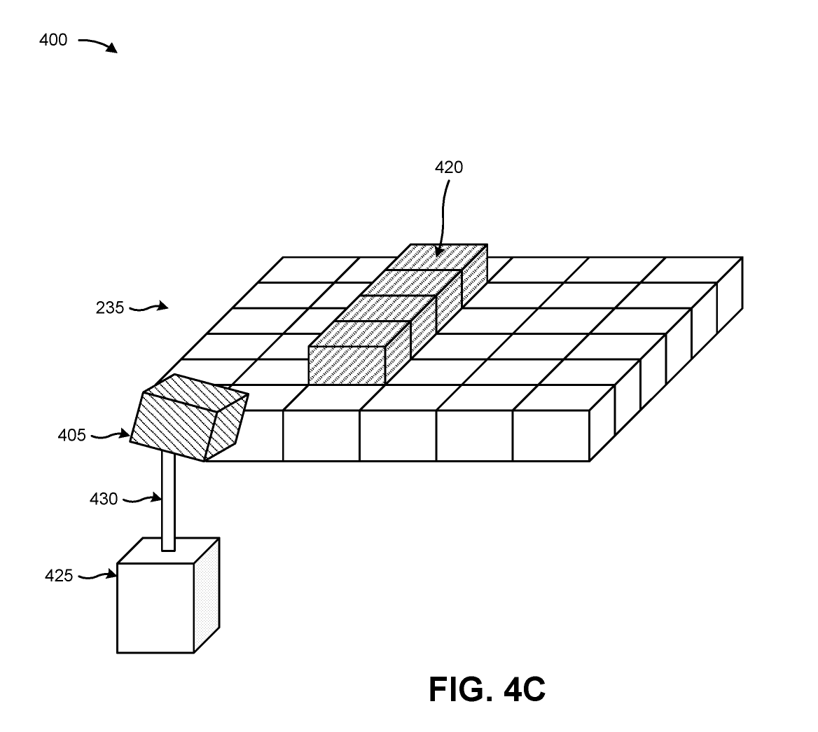

The print bed 235 may include a nominally flat surface onto which objects 250 are printed layer-by-layer. In some implementations, the print bed 235 may be movable and may include various configurations, as described below in connection with FIGS. 4A-4C. The print bed 235 may provide a stable and even surface for the object 250 to adhere to during printing. The print bed 235 may provide a surface for the object 250 to take shape, layer-by-layer, with each layer being deposited onto the print bed 235. The print bed 235 may help the object 250 adhere to the print bed 235 in order to prevent the object 250 from detaching or warping during the printing process. In some implementations, the print bed 235 may be heated or cooled to control the temperature of the object 250 being printed. In some implementations, the print bed 235 may include a fixed print bed that remains stationary during the printing process, a removable build plate that can be detached from the three-dimensional printer after printing, a heated print bed to heat the object 250 being printed, a cooled print bed to cool the object 250 being printed, and/or the like.

In some implementations, three-dimensional printing may utilize three linear orthogonal axes (x, y, z) 225, 240. Movement along the axes 225, 240 may be performed either by moving the print nozzle 215 or by moving the print bed 235. Other dimensions may also be used, such as 5D printing based on using additional rotational axes 230, 245. The 5D printing movement may be performed either by moving the print nozzle 215 (e.g., as shown by 230) or by moving the print bed 235 (as shown by 245).

The tester 255 may include a component that tests whether the object 250 is adhering to the print bed 235. The tester 255 may utilize various mechanisms to perform a test. For example, the tester 255 may cause movement of the object 250 at regular intervals. In some implementations, this can be achieved by shaking movable elements of the print bed 235. In some implementations, the tester 255 may utilize a tensile test and/or a shear test to test whether the object 250 is adhering to the print bed 235. The tester 255 may measure a force needed to pull the object 250 perpendicularly (e.g., a tensile test) or a shear force needed to slide the object 250 (e.g., a shear test). In some implementations, the tester 255 may utilize visual inspection to test whether the object 250 is adhering to the print bed 235. For example, the tester 255 may utilize imaging components and artificial intelligence to identify hairline cracks in the object 250. In some implementations, the tester 255 may utilize a sensor to test whether the object 250 is adhering to the print bed 235. For example, the tester 255 may include incorporating a fiber-tip microforce sensor (FTMS) that can measure adhesion forces at the microscale and/or the nanoscale. In some implementations, the tester 255 may utilize a LiDAR system to test whether the object 250 is adhering to the print bed 235. For example, the tester 255 may include a high-resolution LiDAR system that can detect hairline cracks with millimeter-level accuracy. The LiDAR system may be utilized to compare dimensions of an actual object 250 (with adhesive) with expected dimensions of the object 250. Identified differences may indicate adhesive problems.

The computer system 260 may correspond to the computer 102, the remote server 108, a system provided by the public cloud 110, and/or a system provided by the private cloud 112. In some implementations, the computer system 260 may perform and/or cause to be performed the functionality described herein in connection with FIGS. 3A-3E, 4A-4C, 5A-5H, 6, and 7. Although implementations described herein depict the computer system 260 being associated with a single three-dimensional printer 205, in some implementations, the computer system 260 may be associated with a plurality of three-dimensional printers 205.

As indicated above, FIG. 2 is provided as an example. Other examples may differ from what is described with regard to FIG. 2. The number and arrangement of components and/or devices shown in FIG. 2 are provided as an example. In practice, there may be additional components and/or devices, fewer components and/or devices, different component and/or devices, or differently arranged components and/or devices than those shown in FIG. 2. Furthermore, two or more components and/or devices shown in FIG. 2 may be implemented within a single component and/or device, or a single component and/or device shown in FIG. 2 may be implemented as multiple, distributed components and/or devices. Additionally, or alternatively, a set of components and/or devices (e.g., one or more components and/or devices) shown in FIG. 2 may perform one or more functions described as being performed by another set of components and/or devices shown in FIG. 2.

FIGS. 3A-3E are diagrams depicting example steps 300 for automatically applying adhesive by the three-dimensional printer 205 (e.g., in conjunction with the computer system 260). As shown in FIG. 3A, the three-dimensional printer 205 may follow a first layer path to apply or print a first layer of adhesive 305 on the print bed 235. In some implementations, the three-dimensional printer 205 may utilize motion components (not depicted) to move along the first layer path and to apply the first layer of adhesive 305. The three-dimensional printer 205 may move along the axes (e.g., axes 225, 230, 240, and 245 depicted in FIG. 2) linearly or rotationally, depending on capabilities of the three-dimensional printer 205.

As shown in FIG. 3B, the three-dimensional printer 205 may switch to a filament material and may continue the printing. In some implementations, the three-dimensional printer 205 may print a first layer of filament material 310 on the first layer of adhesive 305. In some implementations, the three-dimensional printer 205 may utilize motion components (not depicted) to move and to print the first layer of filament material 310. The three-dimensional printer 205 may move along the axes (e.g., axes 225, 230, 240, and 245 depicted in FIG. 2) linearly or rotationally, depending on capabilities of the three-dimensional printer 205.

As shown in FIG. 3C, the three-dimensional printer 205 may print a second layer of filament material 315 on the first layer of filament material 310. In some implementations, the three-dimensional printer 205 may utilize motion components (not depicted) to move and to print the second layer of filament material 315. The three-dimensional printer 205 may move along the axes (e.g., axes 225, 230, 240, and 245 depicted in FIG. 2) linearly or rotationally, depending on capabilities of the three-dimensional printer 205. As further shown in FIG. 3C, the computer system 260 may analyze the first layer of adhesive 305, the first layer of filament material 310, and the second layer of filament material 315 to identify a stress point 320 associated with the structure. Based on identifying the stress point 320, the computer system 260 may determine that one or more additional adhesive layers may be required.

As shown in FIG. 3D, in response to determining that one or more additional adhesive layers are required, the three-dimensional printer 205 may switch back to its adhesive nozzle (e.g., either via the print nozzle 215 or the switching nozzle 220) and may angle the adhesive nozzle so that a second layer of adhesive 325 may be applied at the stress point 320. Thus, the three-dimensional printer 205 may provide for an even stronger attachment to the print bed 235. In some implementations, a three-dimensional printer 205 with more than three axes may be utilized to apply the adhesive into angled joints between a printed model and the print bed 235, and also into the stress point 320. As shown in FIG. 3D, the second layer of adhesive 325 may be provided next to the first layer of filament material 310 and below the second layer of filament material 315.

FIG. 3E depicts another example associated with providing additional adhesive 325 (e.g., in a wedge shape or triangle shape) next to a set of filaments 330. This implementation may be particularly suitable for unstable prints (e.g., a print that is thin and vertical) resulting in a buttress of the additional adhesive 325 being formed.

As indicated above, FIGS. 3A-3E are provided as an example. Other examples may differ from what is described in connection with FIGS. 3A-3E.

FIGS. 4A-4C are diagrams depicting an example 400 of print beds 235 of the three-dimensional printer. As shown in FIG. 4A, the print bed 235 may include a number of elements 405, 410, 415, and 420. In some implementations, the print bed 235 may include a grid of regular cubic elements 405, 410, 415, and 420. As further shown in FIG. 4A, the print bed 235 may be associated with a control component 425 and a conduit 430 that is attached to one of the elements (e.g., element 405). Only one control component 425 and one conduit 430 are depicted for simplicity. In some implementations, a separate control component 425 and conduit 430 may be associated with each of the elements 405, 410, 415, and 420.

As further shown in FIG. 4A, the element 410 is depicted as enlarged to show an opening 435 in the element 410 that acts as a channel for the adhesive. In some implementations, openings may be provided in the other elements 405, 415, and 420, but are not depicted for simplicity. As further shown, the elements 415 are depicted as enlarged to show openings 435 (e.g., gaps or spacings) between the elements 415 that may alternatively act as channels for the adhesive.

In some implementations, the three-dimensional printer 205 may provide the adhesive in a measured amount to a set of elements 420 of the print bed 235. The adhesive compound may spread across the set of elements 420 through the openings 435 provided in each of the elements 420. The adhesive may be supplied from a reservoir in the control component 425 and through the conduits 430 to each of the elements 420. In some implementations, the three-dimensional printer 205 may clean the conduits 430 and the openings 435 of the set of elements 420, after the adhesive has been applied, so that additional adhesive may be applied in the future. In some implementations, heating elements (not depicted) may be embedded in the elements 405, 410, 415, and 420. In such implementations, the heating elements may be utilized so that contact areas of the adhesive on the print bed 235 are selectively heated and/or cooled to create a better bond. The computer system 260 may control the heating or cooling control of the elements 405, 410, 415, and 420.

In some implementations, different elements (e.g., of the elements 405, 410, 415, and 420) may be separately moved relative to other elements (e.g., of the elements 405, 410, 415, and 420). For example, one or more elements may be raised and/or tilted using actuator mechanisms (not depicted) controlled by the computer system 260. The raising and/or tilting of the elements of the print bed 235 may provide for finer control of layers of adhesive. In some implementations, the raised elements of the print bed 235 may facilitate the printing of overhangs and may be heated to enable better adhesion of the raised printed area with the print bed 235.

As shown in FIG. 4B, the elements 405, 410, 415, and 420 of the print bed 235 may include shapes other than the cubic shape shown in FIG. 4A. For example, the elements 405, 410, 415, and 420 of the print bed 235 may include a set of regular hexagons 440, a set of pentagons, an irregular grid of various different polygons 445 (e.g., pentagons), and/or the like.

As shown in FIG. 4C, in some implementations, the elements 405, 410, 415, and 420 of the print bed 235 may be supported for independent movement. Alternatively, one or more of the elements 405, 410, 415, and 420 of the print bed 235 may also be twistable relative to the other elements (e.g., when the elements 440 and 445 are polygonal or even circular). When each of the elements 405, 410, 415, and 420 of the print bed 235 are positioned at a reference level, the elements 405, 410, 415, and 420 may form different parts of a common plane of the print bed 235. A linear actuator may be connected to each of the elements 405, 410, 415, and 420, respectively, and may be configured to generate independent movement of the elements 405, 410, 415, and 420 and to effect positioning of the elements 405, 410, 415, and 420 (e.g., to tilt an element or to raise elements, as shown in FIG. 4C). The linear actuators may be configured to lower the elements 405, 410, 415, and 420 in a staggered manner so that a release wave may be generated and used to remove a printed object from the print bed 235.

As indicated above, FIGS. 4A-4C are provided as an example. Other examples may differ from what is described in connection with FIGS. 4A-4C.

FIGS. 5A-5H are diagrams of an example 500 associated with automatically applying adhesive for three-dimensional printing. As shown in FIGS. 5A-5H, the example 500 includes the computer system 260 associated with the three-dimensional printer 205. The computer system 260 may correspond to the computer 102, the remote server 108, a system provided by the public cloud 110, and/or a system provided by the private cloud 112. Further details of the three-dimensional printer 205 and the computer system 260 are provided elsewhere herein.

As shown in FIG. 5A, and by reference number 505, the computer system 260 may create a digital model of an object for the three-dimensional printer 205. For example, the computer system 260 may create a three-dimensional computer-aided design (CAD) model of an object. A three-dimensional CAD model may include a digital representation of a physical object or design created using CAD software. The computer system 260 may utilize the three-dimensional CAD model to instruct the three-dimensional printer 205 on how to create the object.

As shown in FIG. 5B, and by reference number 510, the computer system 260 may convert the digital model into a converted digital model in a format readable by slice software. For example, the computer system 260 may analyze a file format of the digital model to determine its compatibility with the slice software. The computer system 260 may check the file extension, header, and metadata to identify the file format and its version. The computer system 260 may extract geometric data from the digital model, including vertices, edges, and faces. This data may represent a three-dimensional shape of the object and may be used to generate the converted digital model. The computer system 260 may convert the extracted geometric data into a format compatible with the slice software. This may include converting the data from a CAD format to a format specific to the slice software, such as G-code. The computer system 260 may export the converted digital model in the desired format, which is now readable by the slice software.

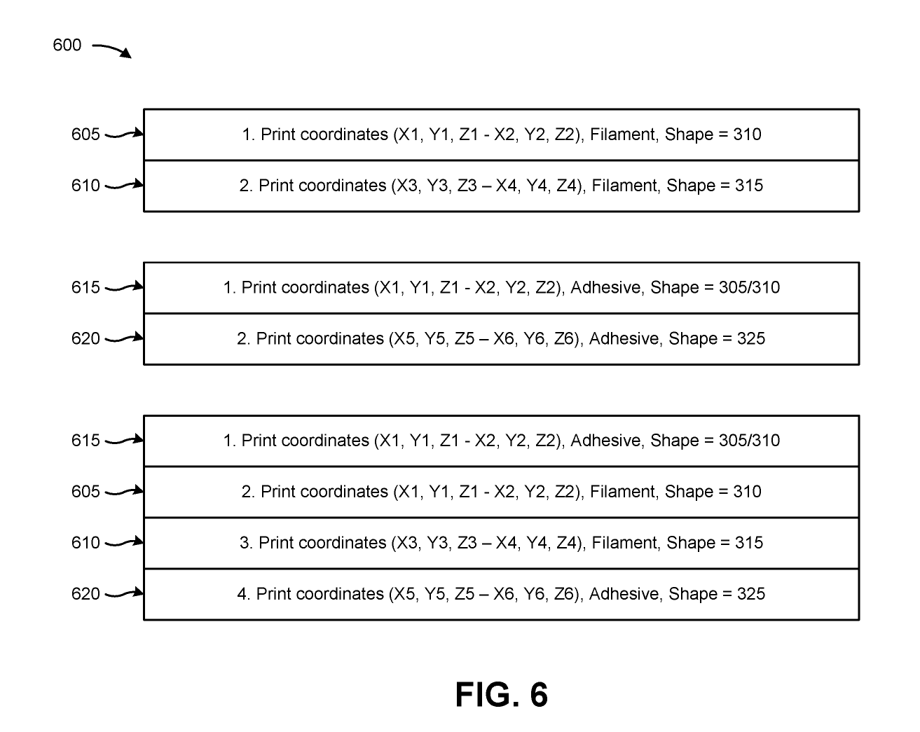

As shown in FIG. 5C, and by reference number 515, the computer system 260 may utilize the slicer software to slice the converted digital model into a list of model layers, may calculate optimal print head paths, and may generate commands for each of the model layers. For example, the computer system 260 may utilize the slicer software to slice the converted digital model into a list of model layers. The computer system 260 may utilize the slicer software to import the converted digital model, and may initialize the slicer software by setting up the software’s parameters, such as layer thickness, infill density, and printing speed. The slicer software may analyze the converted digital model to determine its geometric complexity, such as the number of vertices, edges, and faces. The slicer software may slice the converted digital model into a list of model layers. For each layer, the slicer software may generate data representing the layer’s geometry, such as the layer’s thickness, boundaries, and infill patterns. The slicer software may generate a printing path for each layer (e.g., the optimal paths of the print head 210), which defines the order and pattern in which the three-dimensional printer 205 will deposit material. This may include optimizing the paths to minimize printing time, material usage, and defects. The slicer software may create a list of model layers, where each layer is represented by its geometric data, printing path, and other relevant information. In some implementations, the slicer software may generate G-code commands for each of the model layers. Examples of such G-code commands are described below in connection with FIG. 6. The stream of model commands may be provided to the three-dimensional printer 205.

As shown in FIG. 5D, and by reference number 520, the computer system 260 may calculate a footprint of the object based on the list of model layers, the optimal print head paths, and the commands, and may determine a location to apply an adhesive on the footprint. For example, the computer system 260 may read forward in the G-code for commands for printing the first model layer of the object to print. Using data points determined for the first model layer, the computer system 260 may calculate an overall polygon of contact (e.g., a footprint) with the print bed 235. The computer system 260 may calculate an overlap of the footprint of the print with individual elements of the print bed 235, and may calculate which areas of the print bed 235 require application for the particular print based on calculating the overlap of the footprint. In some implementations, the computer system 260 may perform these calculations by utilizing a model, such as a sweep line computational geometry model. A sweep line is a computational geometry technique used to efficiently process geometric data, particularly in the context of geometric models. In essence, a sweep line is an imaginary line that moves or sweeps through a geometric space, dividing the space into two regions, a visited region and an unvisited region. In some implementations, the computer system 260 may determine the location to apply the adhesive on the footprint based on the calculated overlap and the calculated areas of the print bed 235.

As shown in FIG. 5E, and by reference number 525, the computer system 260 may cause the three-dimensional printer 205 to apply a first layer of adhesive 305 on the footprint at the location. For example, the computer system 260 may generate commands to control the three-dimensional printer 205 to apply the first layer of adhesive 305. These commands may include a type of adhesive to be applied (e.g., cyanoacrylate, epoxy, or hot glue), an amount of adhesive to be applied (e.g., measured in grams, milliliters, or drops), a speed at which the adhesive is to be applied (e.g., measured in millimeters per second or inches per minute), and a pattern in which the adhesive is to be applied (e.g., continuous bead, intermittent dots, or zigzag). The computer system 260 may send the generated commands to the three-dimensional printer 205 via a communication interface, such as a bus connection, an Ethernet connection, or a wireless communication. The three-dimensional printer 205 may activate its adhesive application system, which may include an adhesive pump that dispenses the adhesive through a nozzle or applicator, an adhesive valve that controls the flow of adhesive to the nozzle or applicator, and adhesive heater that warms the adhesive to a specified temperature. The three-dimensional printer 205 may position the nozzle or applicator over the footprint at the location, using its motion system (e.g., X-Y-Z axes, a gantry, or a robotic arm), and may apply the first layer of adhesive 305, according to the generated commands. This may include the three-dimensional printer 205 moving the nozzle or applicator in the specified pattern to apply the adhesive, and the adhesive pump dispensing the adhesive through the nozzle or applicator, which is then applied to the footprint.

As shown in FIG. 5F, and by reference number 530, the computer system 260 may cause the three-dimensional printer 205 to print a first layer of filament material 310 above the first layer of adhesive 305. For example, the computer system 260 may generate commands to control the three-dimensional printer 205 to print the first layer of filament material 310. These commands may include a type of filament material to be used (e.g., PLA, ABS, PETG, or nylon), a diameter of the filament material, a thickness of the first layer of filament material, a pattern in which the filament material is to be deposited (e.g., linear, zigzag, or spiral), and/or a speed at which the filament material is to be deposited. The computer system 260 may send the generated commands to the three-dimensional printer 205 via a communication interface, such as a bus connection, an Ethernet connection, or a wireless communication. The three-dimensional printer 205 may activate its extruder, which is responsible for melting and depositing the filament material, and may heat the extruder to a specified temperature, which is dependent on the type of filament material. The three-dimensional printer 205 may load the filament material into the extruder, which is then melted and extruded through the nozzle. The three-dimensional printer 205 may position the nozzle above the first layer of adhesive 305, using its motion system (e.g., X-Y-Z axes, a gantry, or a robotic arm). The three-dimensional printer 205 may print the first layer of filament material 310, according to the generated commands, by moving the nozzle in the specified pattern to deposit the filament material, and extruding the melted filament material through the nozzle, which is then deposited onto the first layer of adhesive 305.

As shown in FIG. 5G, and by reference number 535, the computer system 260 may analyze the digital model to identify a stress point 320. For example, the computer system 260 may analyze the geometry of the digital model to identify areas of high stress concentration, which can be caused by sharp angles, thin walls, and/or junctions. In some implementations, the computer system 260 may perform a finite element analysis on the digital model to simulate the behavior of the object under various loads, such as mechanical loads, thermal loads, and/or the like. The computer system 260 may calculate a stress distribution within the digital model, using the results of the finite element analysis, and may identify areas of high stress concentration, which are potential stress points 320. The computer system 260 may rank the stress points 320 based on their severity (e.g., according to a stress magnitude, a stress direction, or a distance from critical features). The computer system 260 may identify the highest ranked potential stress point as the stress point 320.

As shown in FIG. 5H, and by reference number 540, the computer system 260 may cause the three-dimensional printer 205 to apply a second layer of adhesive 325 at the stress point 320. For example, the computer system 260 may generate commands to control the three-dimensional printer 205 to apply the second layer of adhesive 325. These commands may include a type of adhesive to be applied, an amount of adhesive to be applied (e.g., measured in grams, milliliters, or drops), a speed at which the adhesive is to be applied (e.g., measured in millimeters per second or inches per minute), and a pattern in which the adhesive is to be applied (e.g., continuous bead, intermittent dots, or zigzag). The computer system 260 may send the generated commands to the three-dimensional printer 205 via a communication interface, such as a bus connection, an Ethernet connection, or a wireless communication. The three-dimensional printer 205 may position the nozzle above the stress point 320, using its motion system (e.g., X-Y-Z axes, a gantry, or a robotic arm), and may apply the second layer of adhesive 325, according to the generated commands, by moving the nozzle in the specified pattern to apply the adhesive and dispensing the adhesive through the nozzle, which is then applied to the stress point 320.

In this way, the computer system (e.g., the computer system 260) automatically applies adhesive for three-dimensional printing. For example, the computer system may optimize adhesion and release of three-dimensional printed objects from a print bed by automating the application of adhesives. The computer system may reduce variability in the printing process and may minimize a risk of defects caused by human error. The computer system may cause precise application of adhesive, which reduces material waste, decreases the likelihood of print quality issues, and enables the production of complex geometries and shapes. Furthermore, the computer system may optimize print bed utilization and increase overall throughput of the three-dimensional printer. Thus, the computer system conserves computing resources, networking resources, and/or the like that would otherwise have been consumed by generating damaged unusable objects due to detachment during a three-dimensional printing process, generating damaged unusable objects upon removal from a three-dimensional printer, wasting materials and three-dimensional printer resources by generating damaged unusable objects, and/or the like.

As indicated above, FIGS. 5A-5H are provided as an example. Other examples may differ from what is described with regard to FIGS. 5A-5H. The number and arrangement of devices shown in FIGS. 5A-5H are provided as an example. In practice, there may be additional devices, fewer devices, different devices, or differently arranged devices than those shown in FIGS. 5A-5H. Furthermore, two or more devices shown in FIGS. 5A-5H may be implemented within a single device, or a single device shown in FIGS. 5A-5H may be implemented as multiple, distributed devices. Additionally, or alternatively, a set of devices (e.g., one or more devices) shown in FIGS. 5A-5H may perform one or more functions described as being performed by another set of devices shown in FIGS. 5A-5H.

FIG. 6 is a diagram depicting example pseudocode 600 capable of being executed by the three-dimensional printer. As shown, the pseudocode 600 may include a list of model commands and shapes of various types of materials used to print the layers 305 and 325 of the adhesive and the layers 310 and 315 of the filament material. Slicing the digital model may create the list of model commands, where the list is ordered according to an order of printing. A first model command 605 may include a command to print the first layer of filament material 310 and may include print coordinates X1, Y1, Z1 – X2, Y2, and Z2. A second model command 610 may include a command to print the second layer of filament material 315 and may include print coordinates X3, Y3, Z3 – Z4, Y4, and Z4. A third model command 615 may include a command to print the first layer of adhesive 305 and may include print coordinates X1, Y1, Z1 – X2, Y2, and Z2. A fourth model command 620 may include a command to print the second layer of adhesive 325 and may include print coordinates X5, Y5, Z5 – X6, Y6, and Z6.

The computer system 260, having identified the footprint (equivalent to the first layer of filament material 310), may create a copy of the first model command 605 as the third model command 615. The computer system 260 may insert the third model command 615 into the list of model commands before the first model command 605. Therefore, the list of model commands may be enhanced with the third model command 615 that applies adhesive. The fourth model command 620 may be provided after the second model command 610 to complete the list of model commands.

FIG. 6 is provided as an example. Other examples may differ from what is described with regard to FIG. 6.

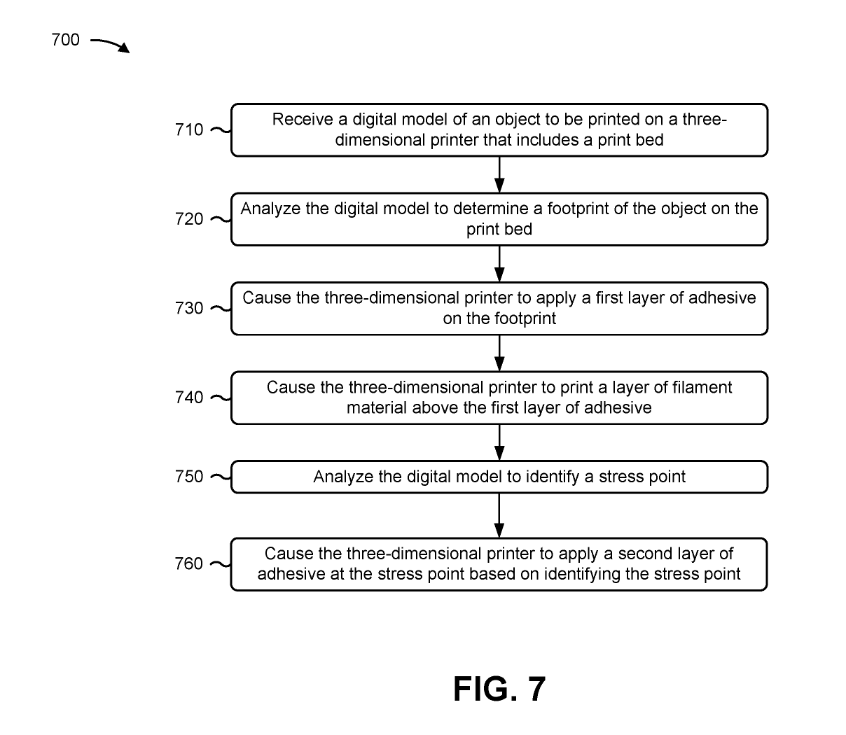

FIG. 7 is a flowchart of an example process 700 associated with automatically applying adhesive for three-dimensional printing. One or more process blocks of FIG. 3 are performed by a computer system (e.g., computer 102 and/or the computer system 260 of the three-dimensional printer 205) and/or by another device or a group of devices separate from or including the computer system. Additionally, or alternatively, one or more process blocks of FIG. 7 may be performed by one or more components of computer 102, such as processor set 114, communication fabric 116, volatile memory 118, and/or analysis code 150.

As shown in FIG. 7, process 700 may include receiving a digital model of an object to be printed on a three-dimensional printer that includes a print bed (block 710). For example, the computer system may receive a digital model of an object to be printed on a three-dimensional printer that includes a print bed, as described above.

As further shown in FIG. 7, process 700 may include analyzing the digital model to determine a footprint of the object on the print bed (block 720). For example, the computer system may analyze the digital model to determine a footprint of the object on the print bed, as described above.

As further shown in FIG. 7, process 700 may include causing the three-dimensional printer to apply a first layer of adhesive on the footprint (block 730). For example, the computer system may cause the three-dimensional printer to apply a first layer of adhesive on the footprint, as described above. In some implementations, causing the three-dimensional printer to apply the first layer of adhesive includes causing the three-dimensional printer to print the first layer of adhesive on the footprint. In some implementations, causing the three-dimensional printer to apply the first layer of adhesive includes causing the three-dimensional printer to heat or cool an element of the print bed under the footprint when applying the first layer of adhesive. In some implementations, causing the three-dimensional printer to apply the first layer of adhesive includes causing the three-dimensional printer to move an element of the print bed relative to another element of the print bed when applying the first layer of adhesive.

As further shown in FIG. 7, process 700 may include causing the three-dimensional printer to print a layer of filament material above the first layer of adhesive (block 740). For example, the computer system may cause the three-dimensional printer to print a layer of filament material above the first layer of adhesive, as described above.

As further shown in FIG. 7, process 700 may include analyzing the digital model to identify a stress point (block 750). For example, the computer system may analyze the digital model to identify a stress point, as described above. In some implementations, analyzing the digital model to identify the stress point includes analyzing whether the filament material is adhering to the print bed. In some implementations, analyzing whether the filament material is adhering to the print bed includes one or more of shaking the print bed to determine whether the filament material is adhering to the print bed, testing a tensile strength of the object to determine whether the filament material is adhering to the print bed, testing a shear strength of the object to determine whether the filament material is adhering to the print bed, utilizing image processing to determine whether the filament material is adhering to the print bed, utilizing a fiber-tip microforce sensor to determine whether the filament material is adhering to the print bed, or utilizing LiDAR to determine whether the filament material is adhering to the print bed.

As further shown in FIG. 7, process 700 may include causing the three-dimensional printer to apply a second layer of adhesive at the stress point based on identifying the stress point (block 760). For example, the computer system may cause the three-dimensional printer to apply a second layer of adhesive at the stress point based on identifying the stress point, as described above. In some implementations, the first layer of adhesive and the second layer of adhesive are applied using a nozzle-based or bed-based adhesive application system. In some implementations, the nozzle-based adhesive application system includes a five-axis nozzle configured to apply the first layer of adhesive and the second layer of adhesive to the print bed. In some implementations, the first layer of adhesive and the second layer of adhesive are applied via a piping system embedded in the print bed. In some implementations, the piping system is arranged in a grid pattern to allow for application of the first layer of adhesive and the second layer of adhesive. In some implementations, causing the three-dimensional printer to apply the second layer of adhesive at the stress point includes causing the three-dimensional printer to apply the second layer of adhesive after causing the three-dimensional printer to print another layer of the filament material. In some implementations, the first layer of adhesive and the second layer of adhesive are selectively heated or cooled to adjust properties during application of the first layer of adhesive and the second layer of adhesive. In some implementations, the print bed includes multiple, individually articulating hexagonal tiles configured to be raised or lowered to adjust application of the first layer of adhesive and the second layer of adhesive.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a digital model of an object to be printed on a three-dimensional printer that includes a print bed;
analyzing the digital model to determine a footprint of the object on the print bed;
causing the three-dimensional printer to apply a first layer of adhesive on the footprint;
causing the three-dimensional printer to print a layer of filament material above the first layer of adhesive;
analyzing the digital model to identify a stress point; and
causing the three-dimensional printer to apply a second layer of adhesive at the stress point based on identifying the stress point.

2. The method of claim 1, wherein the first layer of adhesive and the second layer of adhesive are applied using a nozzle-based or bed-based adhesive application system.

3. The method of claim 2, wherein the nozzle-based adhesive application system includes a five-axis nozzle configured to apply the first layer of adhesive and the second layer of adhesive to the print bed.

4. The method of claim 1, wherein the first layer of adhesive and the second layer of adhesive are applied via a piping system embedded in the print bed.

5. The method of claim 4, wherein the piping system is arranged in a grid pattern to allow for application of the first layer of adhesive and the second layer of adhesive.

6. The method of claim 1, wherein causing the three-dimensional printer to apply the first layer of adhesive comprises:
causing the three-dimensional printer to print the first layer of adhesive on the footprint.

7. The method of claim 1, wherein causing the three-dimensional printer to apply the second layer of adhesive at the stress point comprises:
causing the three-dimensional printer to apply the second layer of adhesive after causing the three-dimensional printer to print another layer of the filament material.

8. A computer system, comprising:
a processor set;
one or more computer-readable storage media; and
program instructions stored on the one or more computer-readable storage media to cause the processor set to perform operations comprising:
receiving a digital model of an object to be printed on a three-dimensional printer that includes a print bed;
analyzing the digital model to determine a footprint of the object on the print bed;
causing the three-dimensional printer to apply a first layer of adhesive on the footprint;
causing the three-dimensional printer to print a layer of filament material above the first layer of adhesive;
analyzing the digital model to identify a stress point; and
causing the three-dimensional printer to apply a second layer of adhesive at the stress point based on identifying the stress point,
wherein the first layer of adhesive and the second layer of adhesive are applied using a nozzle-based or bed-based adhesive application system.

9. The computer system of claim 8, wherein causing the three-dimensional printer to apply the first layer of adhesive comprises:
causing the three-dimensional printer to heat or cool an element of the print bed under the footprint when applying the first layer of adhesive.

10. The computer system of claim 8, wherein causing the three-dimensional printer to apply the first layer of adhesive comprises:
causing the three-dimensional printer to move an element of the print bed relative to another element of the print bed when applying the first layer of adhesive.

11. The computer system of claim 8, wherein analyzing the digital model to identify the stress point comprises:
analyzing whether the filament material is adhering to the print bed.

12. The computer system of claim 11, wherein analyzing whether the filament material is adhering to the print bed comprises one or more of:
shaking the print bed to determine whether the filament material is adhering to the print bed;
testing a tensile strength of the object to determine whether the filament material is adhering to the print bed;
testing a shear strength of the object to determine whether the filament material is adhering to the print bed;
utilizing image processing to determine whether the filament material is adhering to the print bed;
utilizing a fiber-tip microforce sensor to determine whether the filament material is adhering to the print bed; or
utilizing LiDAR to determine whether the filament material is adhering to the print bed.

13. The computer system of claim 8, wherein the first layer of adhesive and the second layer of adhesive are selectively heated or cooled to adjust properties during application of the first layer of adhesive and the second layer of adhesive.

14. The computer system of claim 8, wherein the print bed includes multiple, individually articulating hexagonal tiles configured to be raised or lowered to adjust application of the first layer of adhesive and the second layer of adhesive.

15. A computer program product, comprising:
one or more computer-readable storage media; and
program instructions stored on the one or more computer-readable storage media to perform operations, the operations comprising:
receiving a digital model of an object to be printed on a three-dimensional printer that includes a print bed;
analyzing the digital model to determine a footprint of the object on the print bed;
causing the three-dimensional printer to apply a first layer of adhesive on the footprint;
causing the three-dimensional printer to print a layer of filament material above the first layer of adhesive;
analyzing the digital model to identify a stress point; and
causing the three-dimensional printer to apply a second layer of adhesive at the stress point based on identifying the stress point,
wherein the first layer of adhesive and the second layer of adhesive are applied via a piping system embedded in the print bed.

16. The computer program product of claim 15, wherein causing the three-dimensional printer to apply the first layer of adhesive comprises:
causing the three-dimensional printer to print the first layer of adhesive on the footprint.

17. The computer program product of claim 15, wherein causing the three-dimensional printer to apply the second layer of adhesive at the stress point comprises:
causing the three-dimensional printer to apply the second layer of adhesive after causing the three-dimensional printer to print another layer of the filament material.

18. The computer program product of claim 15, wherein causing the three-dimensional printer to apply the first layer of adhesive comprises:
causing the three-dimensional printer to heat or cool an element of the print bed under the footprint when applying the first layer of adhesive.

19. The computer program product of claim 15, wherein causing the three-dimensional printer to apply the first layer of adhesive comprises:
causing the three-dimensional printer to move an element of the print bed relative to another element of the print bed when applying the first layer of adhesive.

20. The computer program product of claim 15, wherein analyzing the digital model to identify the stress point comprises:
analyzing whether the filament material is adhering to the print bed.
